(19) United States
(12) Patent Application Publication
(10) Pub. No.: US 2025/0026611 A1
(43) Pub. Date: Jan. 23, 2025

(54) MONITORING METHOD FOR ELEVATING MACHINES, PARTICULARLY ELEVATORS AND ESCALATORS

(71) Applicant: MONTANARI GIULIO & C.-SOCIETA' A RESPONSABILITA' LIMITATA, Modena (MO) (IT)

(72) Inventor: Alberto MANTOVANI, Modena (MO) (IT)

(21) Appl. No.: 18/706,820

(22) PCT Filed: Nov. 2, 2022
(86) PCT No.: PCT/IB2022/060564

§ 371 Date: May 2, 2024

(30) Foreign Application Priority Data
Nov. 3, 2021 (IT) 102021000027992

(51) Int. Cl. B66B 5/00; B66B 1/36; B66B 11/04; B66B 23/02; B66B 25/00

(52) U.S. Cl. CPC B66B 5/0037; B66B 5/0025; B66B 25/006; B66B 1/36; B66B 11/043; B66B 23/02

(57) ABSTRACT

The monitoring method for elevating machines (1), particularly elevators and escalators, provided with;—at least one pulley member (2);—motion transmission means (26), coupled to the pulley member (2);—at least one flexible traction member (4), which is at least partly wrapped around the pulley member (2);—at least one transport member (5), connected to the flexible member (4) and moved due to the sliding of the latter;—at least one braking member (6), operating on at least one of either the motion transmission means (26) or the pulley member (2) and activated and deactivated when the motor member (3) is deactivated and activated, respectively, to prevent and allow the rotation of the pulley member (2); wherein the method comprises:—at least one acquisition phase of at least one operating datum of the machine (1);—at least one processing phase of at least one status parameter of the machine (1) as a function of one or more of said operating data, said status parameter being indicative of at least one of:—the slip between the flexible member (4) and the pulley member (2) during the rotation of the latter,—the rotation of the pulley member (2) during the activation of the braking member (6);—the level of degradation of the machine (1).

### TECHNICAL FIELD

The present invention relates to a monitoring method for elevating machines, particularly elevators and escalators, for the transport of loads and/or people.

### BACKGROUND ART

These types of machine are used to facilitate the movement, usually vertically, of loads and/or people within a building.

In general, the elevating machines of known type make use of a transport member, such as an elevator car or the steps of an escalator, on which loads and/or people are transported from a starting point to an arrival point.

Usually, the transport member is associated with a flexible traction member, such as a belt, a rope or the like, which runs at least partly wrapped around a pulley member thanks to the rotary motion transmitted to the latter by a motor member.

These machines also make use of appropriate braking members which must ensure that the transport member stops when the motor member is deactivated, e.g., when the elevator car reaches the floor or when the escalator is turned off. Generally, the braking members operate directly on the pulley member or on the members transmitting the motion to the latter, so as to stop the sliding of the flexible member and block the position of the transport member.

These types of machine are extremely popular and are used daily by a large number of people who use them to move around within small and large buildings.

It is easy to appreciate, therefore, the need to monitor the operation of such machines so as to ensure the safety of those who use them.

For this reason, a variety of monitoring methods are known which are employed, e.g., to identify faults, malfunctions, state of wear and tear and/or similar conditions of the elevating machines, with the aim of scheduling appropriate repair and/or maintenance jobs.

In particular, the known methods provide for periodic maintenance job that allows the machine to be monitored regularly so as to ensure the safe operation thereof.

During such jobs, the maintainer monitors the proper operation of the machine, paying particular attention to certain aspects that are critical to the safe operation of the machine, including the braking action of the braking member and slip between the flexible member and the pulley member.

In this way, the monitoring methods of known type ensure the safe operation of the elevating machines.

However, these methods are susceptible to some refinements.

In particular, the known methods involve performing maintenance jobs at a scheduled frequency based on specific relevant standards and laws.

As a result, known methods only allow for the detection of any machine malfunction as a result of the periodic intervention and/or as a result of a specific report, such as e.g. from the users of the machine itself.

Therefore, the majority of interventions turn out to be premature, i.e., performed without a real need, or late, i.e., carried out in the face of now obvious operating problems.

In addition, during such operations, to determine the slip between the flexible member and the pulley member, known methods require the maintainer to mark the mutual position of the flexible member with respect to the pulley member when the transport member is at a known starting point.

Next, the method requires the maintainer to manually measure the deviation of the marked position as a result of a round trip to the starting point of the transport member.

Based on the measurement of this deviation, the maintainer verifies the presence of the slip and, therefore, the loss of traction of the pulley member on the flexible member.

However, this procedure turns out to be particularly sloppy and provides a figure that is difficult to interpret.

In addition, due to the mechanical and structural complexity of the elevating machines, it is not always easy to access the pulley member and, therefore, this procedure is particularly inconvenient and complex.

To determine the braking action of the braking member, on the other hand, known methods require the machine's electrical panel to monitor, through micro-contacts on board the machine, that the constituent parts of the brake are not jammed.

Specifically, the electrical panel forcibly stops the machine when it detects that the micro-contacts are not working consistently with the operation of the machine itself.

However, this procedure merely verifies the operation of the braking member, but not the actual braking action of the same.

In fact, this procedure fails to detect the degradation of the braking action of the braking member as a result of causes beyond the operation of the braking member, such as due to oil leakage. In fact, in this case, the oil impairs the friction coefficient of the braking member, yet the micro-contacts continue to operate consistently with the operation of the machine, without reporting any malfunction or degradation of the same.

Such drawbacks are a limitation of the known monitoring methods, which prove to be costly, inconvenient and inadequate to verify the real operating status of the elevating machines and to appropriately schedule the maintenance jobs on the same.

### DESCRIPTION OF THE INVENTION

The main aim of the present invention is to devise a monitoring method for elevating machines, particularly elevators and escalators, which allows checking the slip between the pulley member and the flexible member accurately, easily and precisely.

Another object of the present invention is to devise a monitoring method for elevating machines, particularly elevators and escalators, which allows checking the braking action of the braking member accurately, easily and precisely.

A further object of the present invention is to devise a monitoring method for elevating machines, particularly elevators and escalators, which allows scheduling the maintenance jobs on such machines against real needs.

An additional object of the present invention is to devise a monitoring method for elevating machines, particularly elevators and escalators, which allows evaluating the level of degradation of such machines.

Another object of the present invention is to devise a monitoring method for elevating machines, particularly elevators and escalators, which allows the aforementioned drawbacks of the prior art to be overcome within the framework of a simple, rational, easy and effective to use as well as affordable solution.

The aforementioned objects are achieved by this monitoring method for elevating machines, particularly elevators and escalators, having the characteristics of claim 1.

The aforementioned objects are achieved by this monitoring system for elevating machines, particularly elevators and escalators, having the characteristics of claim 8.

### BRIEF DESCRIPTION OF THE DRAWINGS

Other characteristics and advantages of the present invention will become more apparent from the description of a preferred, but not exclusive, embodiment of a monitoring method for elevating machines, particularly elevators and escalators, illustrated by way of an indicative, yet non-limiting example, in the accompanying tables of drawings in which:

FIG. 1 is a schematic view of the system according to the invention, wherein the elevating machine is an elevator;

FIG. 2 is a detailed view of some components of the system shown in FIG. 1;

FIG. 3 is a schematic view of the system according to the invention, wherein the elevating machine is an escalator;

FIG. 4 is a block diagram of the system according to the invention.

FIG. 5 is another schematic view of the system according to the invention, wherein the machine is an elevator;

FIG. 6 is a detailed view of some components of the system shown in FIG. 5;

FIG. 7 is another block diagram of the system according to the invention.

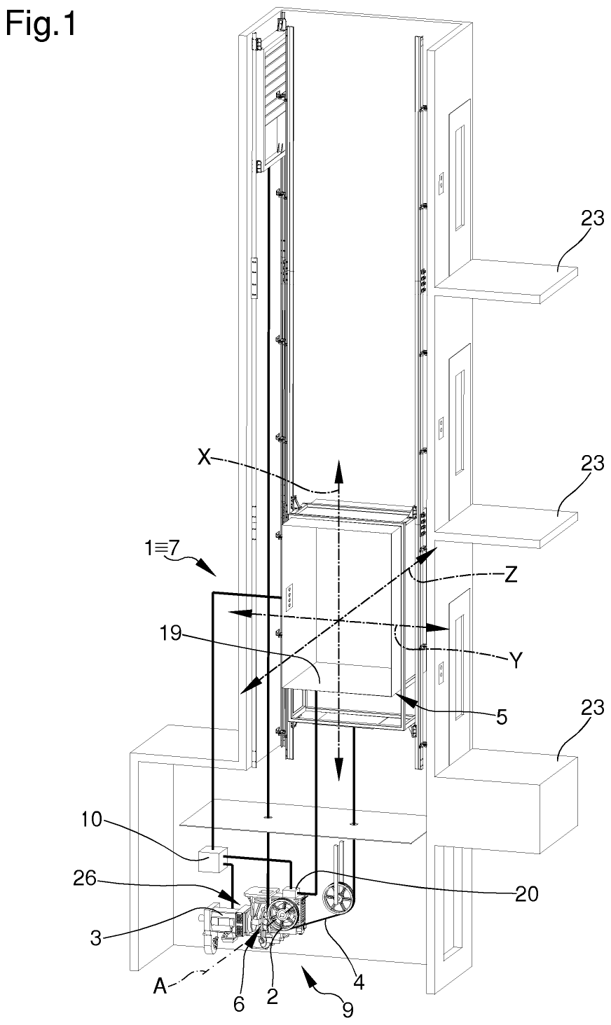

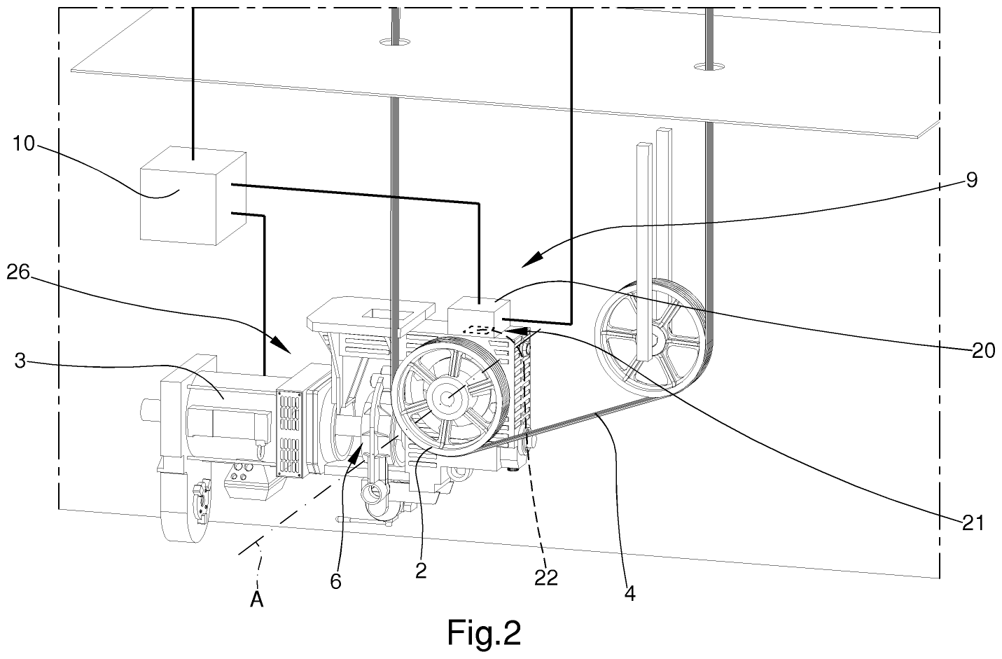

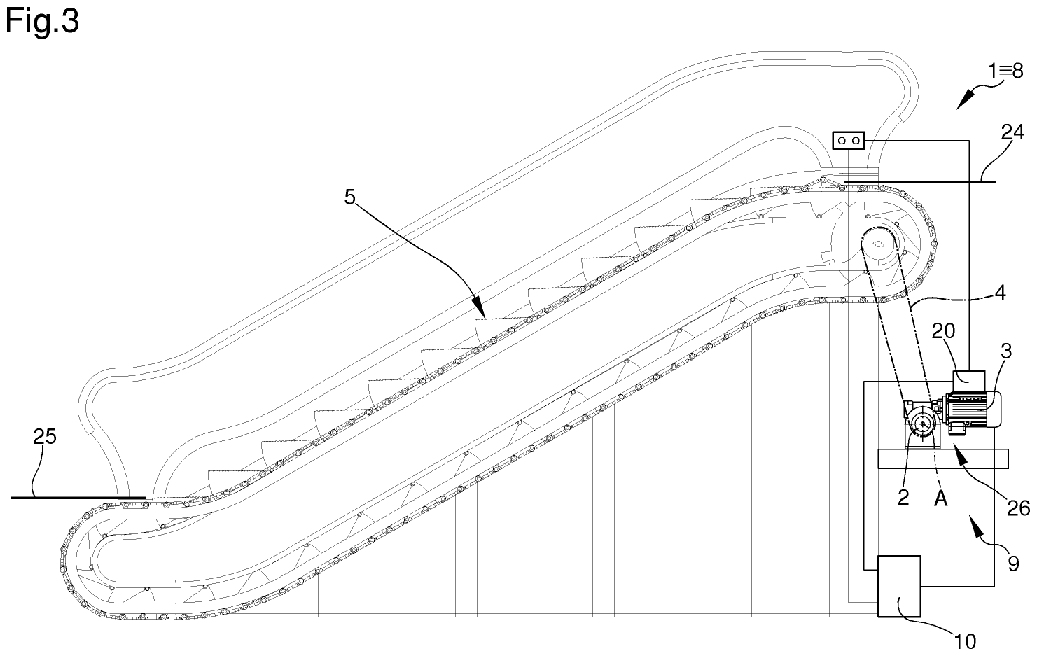

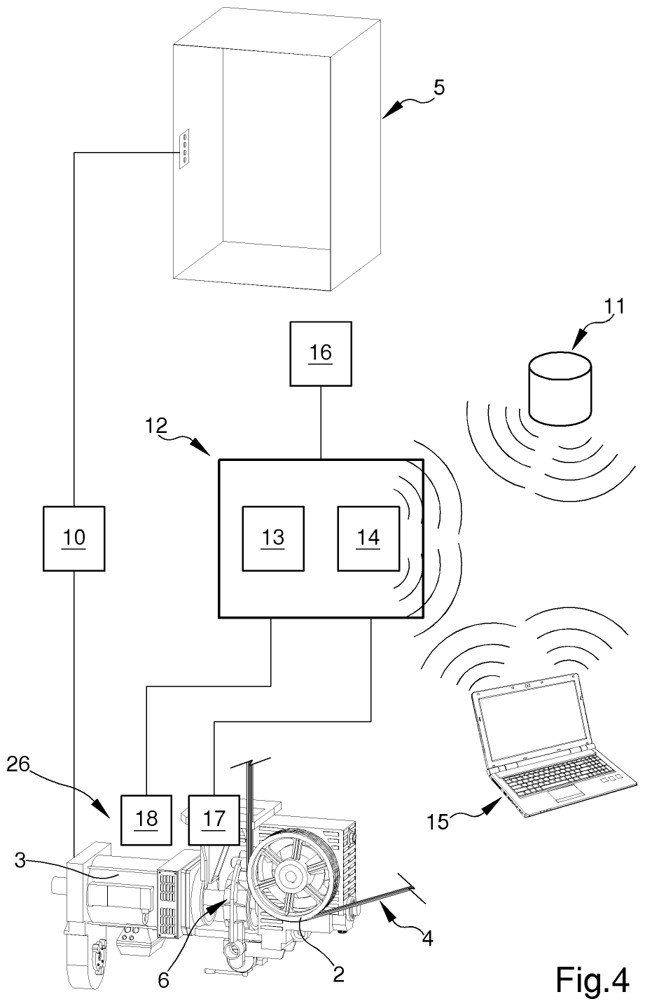

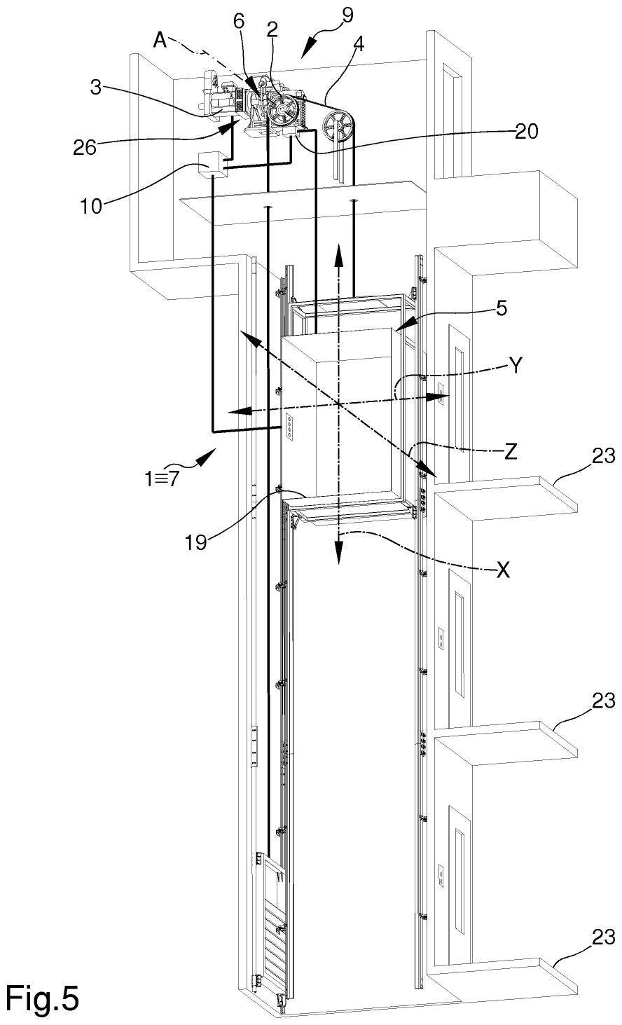

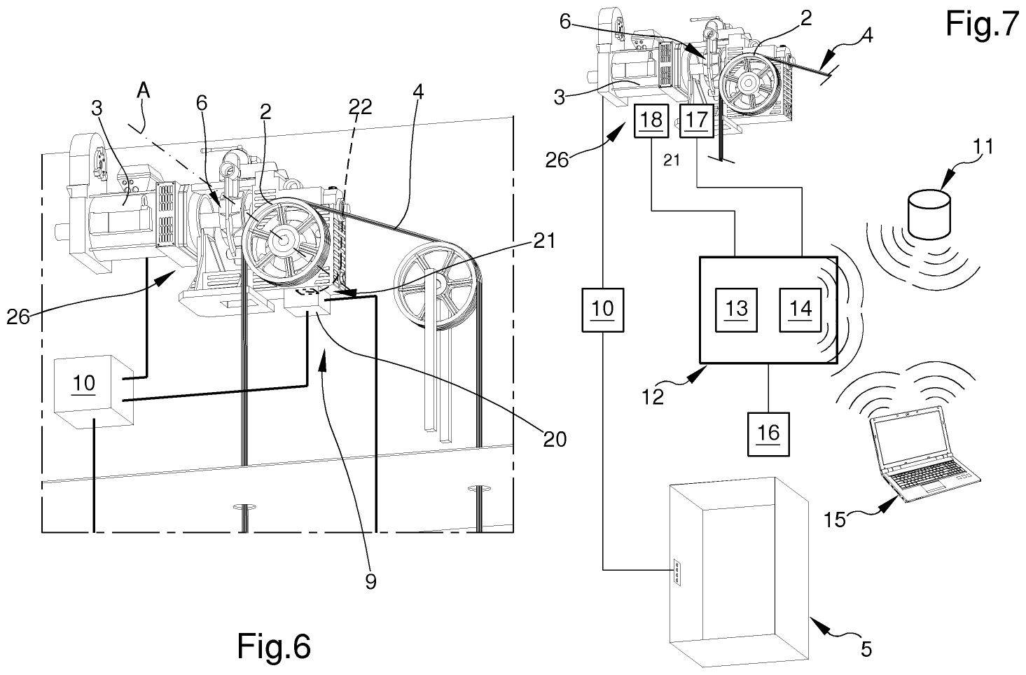

### EMBODIMENTS OF THE INVENTION

The monitoring method for elevating machines 1, particularly elevators and escalators, is provided with:
at least one pulley member 2 which can be activated in rotation around an axis of rotation A for the drive of the machine 1;
motion transmission means 26, coupled to the pulley member 2 in a kinematic manner and provided with at least one motor member 3 configured to generate the motion transmitted to the pulley member 2 to activate it in rotation;
at least one flexible traction member 4, which is at least partly wrapped around the pulley member 2 and moved in a sliding manner due to the friction with the latter during the rotation of the latter;
at least one transport member 5, connected to the flexible member 4 and moved due to the sliding of the latter to transport at least one load/passenger between two or more predefined points 23, 24, 25 as a result of the drive of the machine 1;
at least one braking member 6, operating on at least one of either the motion transmission means 26 or the pulley member 2 and activated and deactivated when the motor member 3 is deactivated and activated, respectively, to prevent and allow the rotation of the pulley member 2.

In particular, the method comprises at least one acquisition phase of at least one operating datum of the machine 1 selected from at least one of ambient temperature, temperature of the motor member 3, torque delivered by the motor 25 member 3, operation of the motor member 3 as a motor and/or generator, current and/or voltage supplied to or generated by the motor member 3, the angular distance travelled by the pulley member 2, the direction of rotation of the pulley member 2, the load of the transport member 5, the position of the transport member 5, the distance travelled by the transport member 5, the 30 vibration of the transport member 5 and the activation/deactivation of the braking member 6.

In addition, the acquisition phase also involves acquiring an operating datum selected from at least one of the speed of the transport member 5, the acceleration of the transport member 5, the deceleration of the transport member 5 and the number of drives of the machine 1.

Preferably, in the following disclosure, the term “acquisition” referring to one or more data means obtaining one or more operating data either by direct acquisition, e.g., by means of appropriate measuring instruments, or by indirect processing and/or estimation, e.g., by means of appropriate processing/calculation tools, starting from other data, such as e.g., other directly acquired operating data.

Conveniently, the method is carried out during normal operation of the elevating machine 1.

In fact, the method covered by the present invention relates to a continuous monitoring method of the operation of the elevating machine 1.

Advantageously, at least one acquisition phase is carried out for each drive of the machine 1 or periodically after a predetermined number of drives.

Preferably, according to the invention, at least one acquisition phase is carried out at each drive of the machine 1.

According to the invention, the acquisition phase and the processing phase are carried out continuously, preferably in continuity and/or at predefined time intervals.

According to the invention, the method comprises at least one processing phase of at least one status parameter of the machine 1 as a function of one or more of the operating data.

Specifically, the status parameter is indicative of at least one of:
the slip between the flexible member 4 and the pulley member 2 during the rotation of the latter;
the rotation of the pulley member 2 during the activation of the braking member 6;
the level of degradation of the machine 1.

Preferably, according to the invention, the method comprises a plurality of processing phases of respective status parameters, where, preferably, each such parameter is indicative of a different item in the aforementioned list.

Advantageously, the processing of the status parameter indicative of the slip comprises at least one processing step of a slip parameter defined as the ratio of:
the distance travelled by the transport member 5 between two of the predefined points 23, 24, 25, calculated as a function of the angular distance travelled by the pulley member 2; and
the distance between the same two predefined points 23, 24, 25.

Advantageously, the processing step of the slip parameter is carried out for a plurality of drives, preferably for each drive of the machine 1.

The distance travelled by the transport member 5, calculated during the processing step of the slip parameter, corresponds to the distance that the transport member 5 should ideally travel as a result of a corresponding angular distance travelled by the pulley member 2.

In fact, ideally, the angular displacement of the pulley member 2 causes the flexible member 4 to slide by a certain length, which corresponds to a specific displacement of the transport member 5.

In this way, the angular distance travelled by the pulley member 2 allows the distance travelled by the transport member 5 to be calculated indirectly.

However, this calculation does not always reflect the actual distance travelled by the transport member 5 because of the slip phenomena that occur between the flexible member 4 and the pulley member 2.

In fact, the distance travelled by the transport member 5, calculated indirectly, takes on a particularly significant value when related to the actual distance travelled by the transport member 5, i.e., the distance between the two predefined points 23, 24, 25 between which the movement of the same transport member occurred.

In particular, in the absence of slip phenomena, this ratio is substantially unitary, since the angular distance travelled by the pulley member 2 causes a displacement of the transport member 5 by a distance substantially equal to the distance between the predefined points 23, 24, 25 between which the same transport member is moved.

However, there is always an inherent slip between the pulley member 2 and the flexible member 4 that depends on various factors, such as e.g. the transported load of the transport member 5 or the like.

Otherwise, the presence of slip phenomena makes this ratio greater than one, since the calculated distance is greater than the actual distance.

In addition, this ratio allows estimating the severity of the slip.

Advantageously, the processing of the status parameter indicative of the slip comprises at least one comparison step of the slip parameters, processed for the respective drives in which the loads of the transport member 5 acquired during such drives are substantially the same.

Preferably, such a comparison involves calculating the difference between the slip parameters.

Appropriately, the comparison is only made between drives for the transport of comparable loads, since the magnitude of the load to be transported affects the in-rush of the motor member 3 and, consequently, the slip.

This expedient makes it possible to detect the gradual increase in slip between the flexible member 4 and the pulley member 2.

In other words, this expedient makes it possible to detect the gradual loss of traction between the flexible member 4 and the pulley member 2.

In fact, in the event of the slip remaining substantially constant over time, the values of slip parameters processed with reference to different drives, under the same load, are substantially equal to each other.

In contrast, in the event of a progressive increase in slip occurring, the values of slip parameters processed with reference to different drives, under the same load, are substantially different from each other.

Appropriately, the processing of the status parameter indicative of the slip of the flexible member 4 around the pulley member 2 is carried out for a plurality of drives of the machine 1, preferably for all of them.

Preferably, the status parameter indicative of the slip is defined as the difference of at least two of the compared slip parameters.

Conveniently, the method comprises at least one phase of reporting the slip that involves sending an alarm signal following the result of such a comparison, preferably when the values of the compared slip parameters are substantially different from each other.

Preferably, the method involves calculating the load of the transport member 5 as a function of the current and/or voltage supplied to or generated by the motor member 3 during the drive of the machine 1.

In fact, the current and/or voltage supplied to or generated by the motor member 3 during the drive of the machine 1 is proportional to the load to be moved by the transport member 5.

Further embodiments of carrying out the method cannot however be ruled out wherein the load of the transport member 5 is detected differently, e.g. by weighing the load carried by the transport member 5.

Conveniently, the processing of the status parameter indicative of the rotation of the pulley member 2 during the activation of the braking member 6 comprises at least one phase of monitoring the variation of at least one of either the angular distance travelled by the pulley member 2 or the current and/or voltage supplied to or generated by the motor member 3 as a result of the activation of the braking member 6.

Specifically, the braking member 6 is active when the motor member 3 is off. In this way, the transport member 5 remains braked when the motor member 3 is inactive, that is, when the machine 1 is off.

In contrast, the braking member 6 is off when the motor member 3 is active, so that the machine 1 can operate.

Therefore, the braking member 6 must be active when the motor member 3 is not powered.

Accordingly, the monitoring phase involves verifying whether the angular distance travelled by the pulley member 2 is substantially zero when the current and/or voltage supplied to or generated by the motor member 3 is substantially zero, i.e., when the motor member 3 is off.

In fact if, as a result of this verification, the angular distance travelled by the pulley member 2 is substantially zero, it means that the braking member 6 is correctly operating on the motion transmission means 26 and/or on the pulley member 2, thus blocking the rotation thereof.

Conversely, if the angular distance travelled by the pulley member 2 is non-zero, it means that the braking action of the braking member 6 is impaired, thus causing the pulley member 2 to rotate, despite the proper drive of the braking member 6.

This expedient makes it possible to evaluate the real braking action of the braking member 6.

Specifically, the angular distance travelled by the pulley member 2 during the activation of the braking member 6 allows the braking action and/or degradation of the same to be evaluated.

According to the invention, the braking member 6 is of the type of a vice braking member, to make, e.g., a disc brake, a drum brake or the like.

Advantageously, the processing of the level of degradation of the machine 1 comprises:
at least one periodic recording step of the value of at least one operating datum;
at least one evaluation step of the level of degradation of the machine 1 as a function of the amplitude and/or of the variation over time of the values of the operating datum.

Usefully, the recording step involves recording the maximum value of the operating datum periodically, preferably once a day.

Preferably, the recording step involves recording a plurality of operating data.

The evaluation step, conveniently, involves estimating the variation in the recorded operating datum with the purpose of evaluating the level of degradation of one or more components of the machine 1.

In addition, it cannot be ruled out that the evaluation step involves combining the estimates of the operating data of different types to evaluate the level of degradation of one or more components of the machine 1.

Preferably, the evaluation step involves comparing a threshold time interval with the time interval between one or more variations occurring in an acquired operating datum.

In this way, as a result of such a comparison, the method makes it possible to estimate and/or to report abnormal and/or marked degradation, e.g., particularly fast, of one or more components of the machine 1.

The evaluation step, preferably, involves comparing a threshold value with the value of one or more of the acquired operating data.

In this way, as a result of such a comparison, the method makes it possible to estimate and/or to report abnormal and/or marked, e.g., particularly high, degradation of one or more components of the machine 1.

In addition, it cannot be ruled out that the evaluation step involves combining the results of the comparisons described above to estimate and/or to report abnormal and/or marked degradation, e.g., malfunction and/or sudden failure, of one or more components of the machine 1.

According to the invention, the recording step involves recording the vibrations, and possibly their frequencies, that the transport member 5 undergoes.

An increase in vibration over time, e.g. above a certain threshold, is caused by, e.g., a performance degradation of one or more components of the machine 1, and it is therefore necessary to proceed with the appropriate technical and/or structural checks, such as a maintenance job.

According to the invention, the recording step involves recording the current and/or voltage supplied to or generated by the motor member 3.

An increase in current and/or voltage supply to the motor member 3 over time, e.g. above a certain threshold, is caused, e.g., by an increase in friction between one or more components of the machine 1 and it is necessary, therefore, to proceed with the appropriate technical and/or structural checks, such as a maintenance job.

According to the invention, the recording step involves recording at least one of the ambient temperature, the temperature of the motor member 3 or the torque of the motor member 3.

Preferably, according to a possible but not exclusive embodiment of the method, the processing of the level of degradation of the machine 1 comprises a step of processing a trend line and/or at least one trend parameter depending on the recorded values of the operating datum.

Advantageously, the evaluation step involves determining the speed and/or amplitude of variation of the trend line of the operating datum over time. Preferably, the trend parameter identifies the speed and/or the amplitude of variation of the operating datum over time.

In fact, a very fast and/or very abrupt variation in the trend line over time (e.g., above a certain threshold) may be caused by a high degree of degradation, breakdown, malfunction or the like of one or more components of the machine 1.

In particular, the analysis of the combination of the trend lines and/or of the trend parameters, in this case of their variation, makes it possible to verify the level of degradation of one or more components of the machine 1.

Usefully, the method provides a graphical representation step of the recorded operating data, so as to allow an operator to appreciate the amplitude and/or variation over time thereof.

Conveniently, the method comprises at least the steps of:
defining a plurality of ranges of at least one of either the current and/or voltage supplied to or generated by the motor member 3, the load of the transport member 5 or the torque delivered by the motor member 3;
allocating to each of the ranges the number of drives and/or the distance travelled by the transport member 5 during the drives in which at least one of either the current and/or voltage supplied to or generated by the motor member 3, the load of the transport member 5 or the torque delivered by the motor member 3 belongs to the respective range;
scheduling at least one maintenance job as a function of the number and/or the distance travelled by the transport member 5 allocated to each of the ranges.

This expedient allows the method to evaluate the actual usage patterns of the machine 1 and to schedule any maintenance and/or inspection job when it is actually needed.

For example, a machine 1 driven a small number of times, where the current and/or voltage supply range of the motor member 3 is particularly high, may require a maintenance and/or inspection job significantly sooner than a similar machine 1 driven a large number of times, where the current and/or voltage supply range of the motor member 3 is particularly low.

Specifically, according to a possible, but not exclusive, embodiment of the method, the machine 1 is an elevator 7 the transport member 5 of which is movable between a plurality of floors, each corresponding to one of the predefined points 23.

In addition, according to this embodiment, the method comprises at least one machine learning phase for determining the number of the predefined points 23 and/or the mutual distance between each of the predefined points 23 as a function of at least one of either the distance travelled by the transport member 5, the angular distance travelled by the pulley member 2, or the direction of rotation of the pulley member 2, acquired during a plurality of drives of the machine 1.

Preferably, in this embodiment of the method, each predefined point 23 is spaced apart from the adjacent one by the same predefined distance.

Further embodiments of the method cannot however be ruled out wherein the predefined points 23 are spaced apart differently from each other.

In this way, the method makes it possible to reconstruct, progressively and accurately, the characteristics of the machine 1 during the operation of the same.

In fact, the method involves recording the distance travelled by the transport member 5 and its direction of movement (determined by the direction of rotation of the pulley member 2) for each drive of the machine 1.

In this way, the machine learning phase allows the number of predefined points 23, i.e., the number of floors, that can be reached by the transport member 5 and/or the distance between them, to be reconstructed.

The faithfulness of such reconstruction increases with the number of drives of the machine 1.

Advantageously, the machine learning phase comprises at least one determination step of the mutual distance of at least two predefined points 23 as a function of the angular distance travelled by the pulley member 2.

Specifically, the determination step involves determining the mutual distance between at least two predefined points 23 as a function of the angular distance travelled by the pulley member 2 and of the diameter of the pulley member itself. In this way, this distance more accurately reflects the true distance between the predefined points 23 the less the effort of the machine 1 to move the transport member 5 between the same predefined points, i.e., the less the current and/or voltage supplying the motor member.

Advantageously, according to the invention, the position of the transport member 5 is determined, preferably in continuity during the operation of the machine 1, as a function of the angular distance travelled by the pulley member 2, the diameter and direction of rotation of the pulley member itself.

Appropriately, the machine learning phase involves increasing the number of predefined points 23 by at least one when, at each drive of the machine 1, the sum of the distance travelled by the transport member 5 in one direction exceeds that of the distance travelled in the opposite direction.

Usefully, the method comprises at least one phase of storing one or more data handled by the method according to the invention.

In the remainder of the following disclosure, the term “managed data” means any digital information acquired, processed, calculated, stored and recorded by the method and/or by the system 9.

According to a further, but not exclusive, embodiment of the method, the machine 1 is an escalator 8, the transport member 5 of which, when the machine is driven, is movable continuously between a predefined point of maximum height 24 and a predefined point of minimum height 25.

In this embodiment, the drive of the machine 1 continuously moves the transport member 5 between at least the predefined points of maximum and minimum height 24, 25.

Specifically, according to this embodiment, the status parameter is indicative of at least one of:
the rotation of the pulley member 2 during the activation of the braking member 6;
the level of degradation of the machine 1.

In fact, in this embodiment, the pulley member 2 and the flexible member 4 mesh with each other by means of a gear, not shown in the figures, e.g., of the type of a gear wheel and a chain, which prevents them from slipping against each other.

According to a further aspect, the present invention relates to a monitoring system 9 for monitoring elevating machines 1, particularly elevators and escalators, for performing the monitoring method, wherein the machine 1 comprises at least one control panel 10 of the machine itself, configured to acquire the operating datum selected from at least one of either the torque delivered by the motor member 3, the operation of the motor member 3 as a motor and/or generator, the current and/or voltage supplied to or generated by the motor member 3, the angular distance travelled by the pulley member 2, the direction of rotation of the pulley member 2, the load of the transport member 5, the position of the transport member 5, the distance travelled by the transport member 5, the speed of the transport member 5 or the activation/deactivation of the braking member 6.

Advantageously, the system 9 is mounted on the machine 1 during the normal operation of the machine 1, thus monitoring the operation thereof in a substantially constant manner over time.

In other words, the system 9 is built with the machine 1.

In fact, the system 9 covered by the present invention refers to a monitoring system of the machine 1 and not to a test system mounted as needed on the machine 1 to check the operation thereof and then disassembled.

Preferably, the control panel 10 is also configured to acquire an operating datum selected from at least one of the speed of the transport member 5, the acceleration of the transport member 5, the deceleration of the transport member 5 or the number of drives of the machine 1.

Specifically, the system 9 comprises acquisition means 16, 17 of the operating datum of the machine 1 selected from at least one of either the ambient temperature, the temperature of the motor member 3 or the vibrations of the transport member 5.

Usefully, the control panel 10 is operatively connected to the sensor means, not shown in the figures, configured to detect one or more of the operating data.

Preferably, the sensor means comprise at least one encoder configured to acquire one or more operating data from the pulley member 2.

It cannot also be ruled out that the sensor means comprise further sensor devices, each configured to acquire a specific operating datum.

For example, it cannot be ruled out that the sensor means comprise a position sensor arranged at each predefined point 23 to identify the presence of the transport member 5 at that point.

Preferably, the control panel 10 comprises an inverter, not shown in the figures, for the operation of the motor member 3.

Specifically, through the inverter, the control panel 10 acquires one or more operating data related to the motor member 3.

Preferably, the control panel 10 comprises a processing unit, not shown in the figures, configured to process the operating data.

According to the invention, the control panel 10 is preferably an electrical panel configured to control the operation of the machine 1.

The system 9 comprises processing means 12, operatively connected to the control panel 10 and to the acquisition means 16, 17, 18 and configured to process at least one of the status parameters of the machine 1.

Advantageously, the processing means 12 are operatively connectable to the control panel 10 of the machine 1.

Furthermore, it cannot be ruled out that the processing means 12 be operatively connectable to the sensor means.

In this way, the system 9 operates in conjunction with and/or takes advantage of one or more components the pre-existing machines 1 are provided with, thus optimally implementing the retrofitting of these machines.

In fact, the control panel 10 with which the elevating machines 1 are generally provided are already configured to acquire at least one of the aforementioned data useful for the implementation of the system 9 and of the method covered by the invention.

Further embodiments of the system 9 cannot however be ruled out, wherein the machine 1 lacks the control panel 10 or wherein it is configured to acquire fewer/different numbers of operating data.

Therefore, with reference to these particular embodiments, the acquisition means 16, 17, 18 are configured to acquire one or more of the operating data necessary for the operation of the system 9 and/or for the method that in other embodiments are acquired from the control panel 10 and/or from the sensor means.

In this way, the system 9 is easily and quickly installed on any machine 1 even if it lacks the control panel 10 and/or the sensor means or wherein the same do not acquire all or part of the operating data necessary to ensure the operability of the system 9 and/or of the method.

According to the invention, the control panel 10 and/or the sensor means of the machine 1 are configured to acquire a plurality, preferably all, of the data listed above.

Preferably, the processing means 12 are of the type of an electronic processing device, such as e.g. a PC, a processor, a microcontroller, a PLC or the like.

Advantageously, the processing means 12 comprise data communication means 14, preferably wireless, configured to send/receive the data managed by the system 9 by means of a data transmission network, such as e.g. the Internet.

Usefully, the system 9 comprises storage means 11, 13 of the data managed by the system 9.

Preferably, the storage means 11, 13 comprise a remote storage unit 11 such as e.g. a server or the like, to which the processing means 12 transmit the data managed by the system 9.

It cannot, however, be ruled out that the storage means 11, 13 comprise a dedicated storage unit 13 operatively connected to the processing means 12.

In this way, the processing means 12 store the data managed by the system 9 within the dedicated storage unit 13.

It cannot also be ruled out that the storage means 11, 13 comprise both storage units 11, 13.

Conveniently, the system 9 comprises interface means 15 configured to allow a user to consult one or more of the data managed by the system 9.

According to the invention, the interface means 15 are of the type of any electronic interface device operatively connected, preferably wirelessly, to at least one of either the processing means 12 or the storage means 11, 13 and configured to allow a user to consult the data managed by the system 9.

Usefully, the acquisition means 16, 17, 18 comprise at least one of:
a temperature sensor 16 configured to detect the temperature of the room wherein the system 9 and/or the machine 1 is installed;
a thermal sensor 17 configured to detect the temperature of the motor member 3;
a gyro sensor 18 configured to detect the vibration of the transport member 5 along at least one reference axis X, Y, Z.

Preferably, the gyro sensor 18 is configured to detect the vibration of the transport member 5 along three substantially transverse reference axes X, Y, Z, preferably orthogonal to each other.

Appropriately, the gyro sensor 18 is associated with the transport member 5.

In particular, the transport member 5 comprises at least one supporting plane 19 arranged, in use, substantially parallel to the ground. In addition, at least one reference axis X, Y, Z is arranged transverse, preferably orthogonal, to the supporting plane 19.

Advantageously, the system 9 comprises at least one containment body 20, associated with the motor member 3 and adapted to contain inside it at least one of either the acquisition means 16, 17, 18, the processing means 12 or the dedicated storage unit 13.

Preferably, the containment body 20 encloses within it only the processing means 12 and the dedicated storage unit 13.

The acquisition means 16, 17, 18, on the other hand, are preferably located outside of the containment body 20, so as to allow the appropriate positioning thereof, as needed, such as e.g. in the proximity of one or more specific components of the machine 1.

Conveniently, the system 9 comprises coupling means 21 of the containment body 20 to the motor member 3 in a removable manner.

Specifically, the coupling means 21 comprise at least one magnetic body 22, associated with the containment body 20 and configured to engage, as a result of magnetic attraction, with the chassis of the motor member 3.

In this way, the processing means 12 are installed easily and smoothly, without the need for complex jobs.

Further embodiments of the system 9 cannot be ruled out wherein it comprises the machine 1.

It has in practice been ascertained that the described invention achieves the intended objects.

In particular, the fact is emphasized that the acquisition and processing phase enables the method and system to monitor the slip between the pulley member and the flexible member, and the braking action of the braking member accurately, easily, and precisely.

In addition, the scheduling phase allows the method and the system to schedule the maintenance jobs on elevating machines against real needs, that is, the actual use and operation of these machines.

In addition, the recording step and the evaluation step allow the level of degradation of the elevating machines monitored by the method and/or system to be evaluated according to the invention.

1. Monitoring method for elevating machines (1), particularly elevators and escalators, provided with:
at least one pulley member (2) which can be activated in rotation around an axis of rotation (A) for the actuation of the machine (1);
motion transmission means (26), coupled to the pulley member (2) in a kinematic manner and provided with at least one motor member (3) configured to generate the motion transmitted to the pulley member (2) to activate it in rotation;
at least one flexible traction member (4), which is at least partly wrapped around the pulley member (2) and moved in a sliding manner due to the friction with the latter during the rotation of the latter;
at least one transport member (5), connected to the flexible member (4) and moved due to the sliding of the latter to transport at least one load/passenger between two or more predefined points (23, 24, 25) as a result of the driving of the machine (1);
at least one braking member (6), operating on at least one of either the motion transmission means (26) or the pulley member (2) and activated and deactivated when the motor member (3) is deactivated and activated, respectively, to prevent and allow the rotation of the pulley member (2);
characterized by the fact that it comprises:
at least one acquisition phase of at least one operating datum of the machine (1) selected from at least one of ambient temperature, temperature of the motor member (3), torque delivered by the motor member (3), operation of the motor member (3) as a motor and/or generator, current and/or voltage supplied to or generated by the motor member (3), the angular distance travelled by the pulley member (2), the direction of rotation of the pulley member (2), the load of the transport member (5), the position of the transport member (5), the distance travelled by the transport member (5), the vibration of the transport member (5) and the activation/deactivation of the braking member (6);
at least one processing phase of at least one status parameter of the machine (1) as a function of one or more of said operating data, said status parameter being indicative of at least one of:
the slip between the flexible member (4) and the pulley member (2) during the rotation of the latter;
the rotation of the pulley member (2) during the activation of the braking member (6);
the level of degradation of the machine (1).

2. Method according to claim 1, characterized by the fact that the processing of said status parameter indicative of the slip comprises at least one of:
at least one processing step of a slip parameter defined as the ratio of:
said distance travelled by the transport member (5) between two of said predefined points (23, 24, 25), calculated as a function of said angular distance travelled by said pulley member (2); and
the distance between the same said two predefined points (23, 24, 25);
at least one comparison step of the slip parameters processed for respective drives in which said loads of the transport member (5) acquired during said drives are substantially the same.

3. Method according to claim 1, characterized by the fact that the processing of said status parameter indicative of the rotation of the pulley member (2) during the activation of the braking member (6) comprises at least one phase of monitoring the variation of at least one of either said angular distance travelled by the pulley member (2) or said current and/or voltage supplied to or generated by the motor member (3) as a result of the activation of the braking member (6).

4. Method according to claim 1, characterized by the fact that the machine (1) is an elevator (7), the transport member (5) of which is movable between a plurality of floors, each corresponding to one of said predefined points (23), and by the fact that it comprises at least one machine learning phase for determining the number of said predefined points (23) and/or the mutual distance between each of said predefined points (23) as a function of at least one of either said distance travelled by the transport member (5), said angular distance travelled by the pulley member (2) or the direction of rotation of the pulley member (2), acquired during a plurality of drives of the machine (1).

5. Method according to claim 1, characterized by the fact that said machine learning phase comprises at least one determination step of the mutual distance of at least two of said predefined points (23) as a function of the angular distance travelled by the pulley member (2).

6. Method according to claim 1, characterized by the fact that the processing of said level of degradation of the machine (1) comprises:
at least one periodic recording step of the value of said at least one operating datum;
at least one evaluation step of the level of degradation of the machine (1) as a function of the amplitude and/or variation over time of the values of said at least one operating datum.

7. Method according to claim 1, characterized by the fact that it comprises at least the steps of:
defining a plurality of ranges of at least one of either said current and/or voltage supplied to or generated by the motor member (3), said load of the transport member (5) or said torque delivered by the motor member (3);
allocating to each of said ranges the number of activations and/or the distance travelled by said transport member (5) during the activations in which at least one of either said current and/or voltage supplied to or generated by the motor member (3), said load of the transport member (5) or said torque delivered by the motor member (3) belongs to said respective range;
scheduling at least one maintenance job as a function of the number and/or the distance travelled by the transport member (5) allocated to each of said ranges.

8. Monitoring system (9) for elevating machines (1), particularly elevators and escalators, for carrying out the method according to claim 1, wherein the machine (1) comprises at least one control panel (10) of the machine itself, configured to acquire said at least one operating datum selected from at least one of either the torque delivered by the motor member (3), the operation of the motor member (3) as a motor and/or generator, the current and/or voltage supplied to or generated by the motor member (3), the angular distance travelled by the pulley member (2), the direction of rotation of the pulley member (2), the load of the transport member (5), the position of the transport member (5), the distance travelled by the transport member (5) or the activation/deactivation of the braking member (6);
characterized by the fact that it comprises:
acquisition means (16, 17, 18) of said at least one operating datum of the machine (1) selected from at least one of either ambient temperature, temperature of the motor member (3) or the vibrations of the transport member (5);
-processing means (12), operatively connected to the control panel (10) and to said acquisition means (16, 17, 18) and configured to process at least one of said status parameters of the machine (1).

9. System (9) according to claim 8, characterized by the fact that it comprises at least one containment body (20), associated with the motor member (3) and adapted to contain inside it at least one of either said acquisition means (16, 17, 18) or said processing means (12).

10. System (9) according to claim 8, characterized by the fact that it comprises coupling means (21) of said containment body (20) to the motor member (3) in a removable manner.
